(19) United States
(12) Patent Application Publication
(10) Pub. No.: US 2008/0156895 A1
(43) Pub. Date: Jul. 3, 2008

(54) FLUX OVERSPRAY REDUCTION APPARATUS, SYSTEMS, AND METHODS

(76) Inventors: James P. Mellody, Phoenix, AZ (US); Sabina J. Houle, Phoenix, AZ (US); James C. Matayabas, Chandler, AZ (US); Oswald L. Skeete, Phoenix, AZ (US)

Correspondence Address: SCHWEGMAN, LUNDBERG & WOESSNER, P.A., P.O. BOX 2938, MINNEAPOLIS, MN, 55402, US

(21) Appl. No.: 11/617,819

(22) Filed: Dec. 29, 2006

(51) Int. Cl. B05B 5/00

(52) U.S. Cl. 239/3; 239/690; 700/90

(57) ABSTRACT

Apparatus and systems, as well as methods and articles, may operate to charge a quantity of flux using a first charge to provide a charged flux portion, dispense the charged flux portion toward a circuit, and direct distribution of the charged flux portion using a second charge to attract or repel the charged flux portion. Other embodiments are described and claimed.

### TECHNICAL FIELD

Various embodiments described herein relate to dispensing flux, including apparatus, systems, and methods used to dispense flux onto circuitry and substrates.

### BACKGROUND INFORMATION

Solder flux may be applied to remove oxide from solder bumps and pads during reflow operations, such as those that involve flip chip assembly. Application methods include jetting (e.g., jet dispensing using a piezoelectric transducer or mechanical piston), where the flux is separated into small volumes and forced through a nozzle, and spraying (e.g., ultrasound spraying), where the flux is pressurized and forced through a nozzle. On occasion, flux overspray results.

Masking, nozzle design, and process optimization have not provided useful solutions to this problem. For example, masking can lead to build-up, and subsequent dripping of flux from the mask onto the substrate being processed. Excessive amounts of misdirected flux during circuit package assembly can obscure fiducials, degrade joint quality, increase the possibility of solder fine formation, and enlarge the keep-out zone around the die area. Thus, apparatus, systems, and methods are needed to more effectively reduce flux overspray.

### BRIEF DESCRIPTION OF THE DRAWINGS

FIGS. 1A and 1B illustrate side, cut-away views of apparatus and systems according to various embodiments of the invention.

FIG. 2 is a flow diagram illustrating several methods according to various embodiments of the invention.

FIG. 3 is a block diagram of a computer-readable medium according to various embodiments of the invention.

### DETAILED DESCRIPTION

To address some of the challenges described above, various embodiments of the invention can provide a non-contact method of controlling the pattern of flux distribution. When implemented, some quantity of flux may be charged prior to its application, and the direction of application controlled via repulsion and/or attraction. When repulsion is used, one or more plates having the same charge as the dispensed flux can be used to repel the charged flux away from areas where flux is not desired (e.g., solder paste and keep-out zones). When attraction is used, a conductive medium having a different charge than the dispensed flux can be coupled to selected circuit elements, promoting attraction of the charged flux to the surfaces of selected elements.

For the purposes of this document, “flux” means a fluid that includes a solvent and an acid. A “solvent” means a substance in which another substance is dissolved, forming a solution. The flux used in most of the embodiments described herein comprises an “ionizable flux,” which is a flux that includes ionizable components, such as metal salts (e.g., zinc chloride and sodium bromide), organic salts (e.g., tetraethyl ammonium chloride and ammonium bromide), and compounds incorporating components that can be ionized via solution-phase Bronsted or Lewis acid/base chemistry, including organic alcohols, organic acids, organic amines and water (capable of forming ammonium ions electrostatically in air), and the like, as well as their mixtures. If desired, ionization can also be achieved by the addition of metalloporphyrins which can form stable radical cations electrostatically.

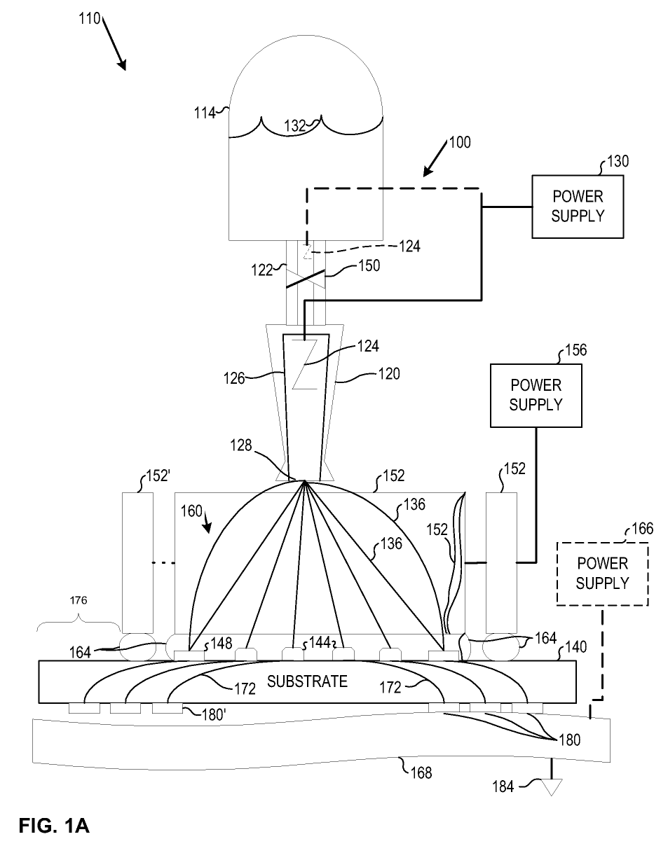

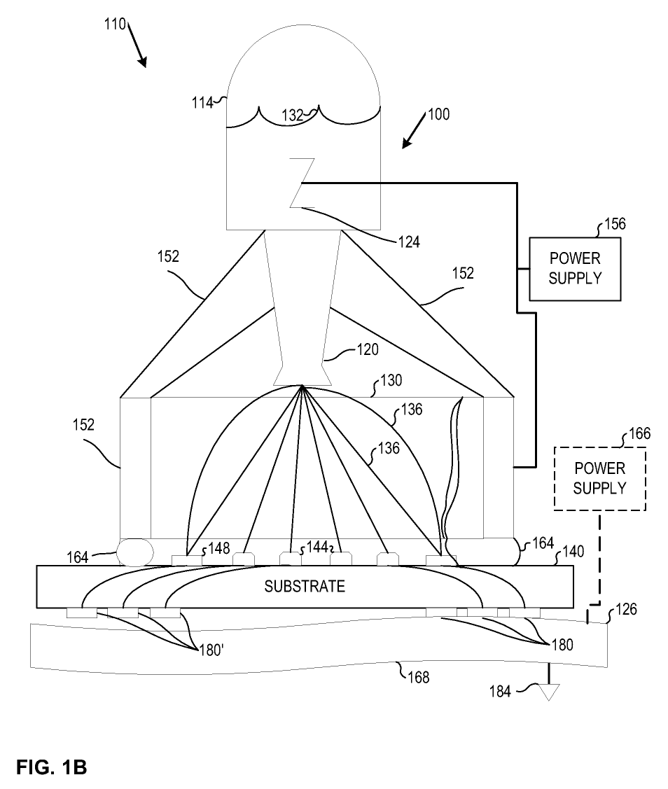

FIGS. 1A and 1B illustrate side, cut-away views of apparatus 100 and systems 110 according to various embodiments of the invention. A flux dispensing apparatus 100 according to some embodiments may comprise a flux reservoir 114 and a dispensing nozzle 120 capable of being in fluid communication with the flux reservoir 114. For example, the dispensing nozzle 120 may communicate with the flux reservoir 114 using a conduit 122. The apparatus 100 may include a valve 150 to control the degree of fluid communication between the flux reservoir 114 and the dispensing nozzle 120, as shown in FIG. 1A. More direct communication may be involved, for example, when the dispensing nozzle 120 forms a portion of the flux reservoir 114, as shown in FIG. 1B.

The apparatus 100 may include a charging electrode 124 proximate to the dispensing nozzle 120 or the flux reservoir 114. The charging electrode 124 may be located within the dispensing nozzle 120 (as shown in FIG. 1A), or within the reservoir 114 (as shown in FIG. 1B). In some embodiments, the charging electrode 124 is disposed within a chamber 126 of the dispensing nozzle 120, the chamber 126 being partially bounded by an outlet 128 of the dispensing nozzle. In some embodiments, the charging electrode 124 is disposed within the conduit 122.

When a charging voltage (e.g., about IkV to about 150 kV) is applied to the charging electrode 124, perhaps supplied via a charging power supply 130 electrically coupled to the charging electrode 124, the charging electrode 124 can operate to electrostatically charge the flux 132 with either a positive or negative charge, depending on the desired dispensing configuration, and the formulation of the flux 132.

A portion of the charged flux 136 may be dispensed in the form of a spray, fluid stream, or series of particles. The charged flux 136 may be dispensed toward a substrate 140 attached to a variety of conductors 180, which in turn may include or be attached to solder bumps 144 (e.g., controlled collapsible chip connection (C4) bumps), and/or solder pads 148 (e.g., die-side capacitor (DSC) pads).

Charged flux 136 overspray may be contained and directed by one or more chargeable plates 152 coupled to a charging power supply 156 and moveable to direct the charged flux 136 exiting the dispensing nozzle 120 away from the plates 152. The power supply 156 coupled to the plates may be different than the power supply 130 coupled to the charging electrode (as shown in FIG. 1A) or the same (as shown in FIG. 1B), depending on the desired configuration of the apparatus 100 and system 110.

Chargeable plates 152 may be formed in a variety of shapes, including substantially curved, substantially straight (as shown in FIGS. 1A and 1B), zig-zag, and other shapes. A single chargeable plate 152, perhaps shaped so as to completely confine the charged flux 136 as it impinges on the substrate 140, may also be used (e.g., shaped as fence that completely bounds the area to receive the charged flux, as shown in FIG. 1B). The chargeable plates 152 may be attached to each other and/or closed on the top and attached to the dispensing nozzle 120 as an integral part of the dispensing nozzle 120 (as shown in FIG. 1B). The chargeable plates 152 may be also be separated and open on top (as shown in FIG. 1A), so as not to form an integral part of the dispensing nozzle 120. Thus, the chargeable plates 152 may be independently manipulated and located proximate to the substrate 140 (see FIG. 1A), or moved as a unit for positioning with respect to the substrate 140 (see FIG. 1B).

In this manner, in some embodiments, substantially identical chargeable plates 152 positioned around the perimeter of the dispensing field 160 can be used to limit the outer extents of charged flux 136 dispensing, such as the spray pattern effected by the dispensing nozzle 120, reducing overspray. Thus, the chargeable plates 152 may comprise two substantially opposable plates (i.e., a single pair of plates). The chargeable plates 152 may also comprise two pairs of substantially opposable plates—as seen in FIG. 1A.

In some embodiments, the apparatus 100 may comprise a flux seal 164 to be located proximate to the chargeable plate(s) 152. The flux seal 164 may be used at the bottom of the chargeable plates 152 to prevent dispensed flux from seeping under the bottom edges of the chargeable plates 152, as well as to set a desired vertical position above the substrate 140 for the chargeable plates 152. The flux seal 164 may comprise a variety of materials, including polytetrafluoroethylene (PTFE), silicone-based rubber, urethane, or a thermoplastic elastomer.

Many other embodiments may be realized. For example, as seen in FIGS. 1A and 1B, a flux dispensing system 110 may include one or more apparatus 100, as described above. The system 110 may also include a conductive medium 168 to electrically couple to a circuit 172 having conductors 180 (e.g., attached to or including solder bumps 144 and pads 148) to attract charged flux 136 exiting the dispensing nozzle 120.

The conductive medium 168 may comprise a substantially compliant conductive medium. For the purposes of this document, a “substantially compliant” conductive medium is one having a durometer of about 30-60 points on the A scale, with a tensile strength of about 100-1000 psi at about 5-100% elongation. The substantially compliant conductive medium may comprise a conductive polymer, a conductive rubber, a conductive mesh, or a compliant solder.

It should be noted that a variety of embodiments may be implemented—some including chargeable plates 152 to repel the charged flux 136 as it is dispensed from the dispensing nozzle 120, and some including a conductive medium 168, to attract the charged flux 136 as it is dispensed from the dispensing nozzle 120. The conductive medium 168 can be charged to a charge opposite the charge on the charged flux 136 using a charging power supply 166. In some embodiments, the conductive medium 168 can be set to a charge different than the charge on the charged flux 136 by grounding the conductive medium 168, using the ground connection 184.

Some embodiments may include the use of both chargeable plates 152 and a conductive medium 168. As an additional aid to controlling flux overspray, the apparatus 100 and system 110 may include one or more non-charged plates 152′ to shield a portion of the substrate 176 from charged flux 136 exiting the dispensing nozzle 120. Particles of charged flux 136 may also be selectively attracted to the circuit 172 on the substrate 140 by coupling the conductive medium 168 to a first portion of the conductors 180, and refraining from coupling the conductive medium 168 to a second portion of the conductors 180′.

Any of the components previously described can be implemented in a number of ways, including simulation via software. Thus, the apparatus 100; systems 110; flux reservoir 114; dispensing nozzle 120; conduit 122; charging electrode 124; chamber 126; outlet 128; charging power supplies 130, 156, 166; flux 132; charged flux 136; substrate 140; solder bumps 144; solder pads 148; valve 150; chargeable plates 152, 152′; dispensing field 160; flux seal 164; conductive medium 168; circuit 172; portion 176; conductors 180, 180′; and ground connection 184 may all be characterized as “modules” herein.

Such modules may include hardware circuitry, single and/or multi-processor circuits, memory circuits, software program modules and objects, and/or firmware, and combinations thereof, as desired by the architect of the apparatus 100 and systems 110, and as appropriate for particular implementations of various embodiments. For example, such modules may be included in a system operation simulation package, such as a software electrical signal simulation package, a power usage and distribution simulation package, a capacitance-inductance simulation package, a power/heat dissipation simulation package, a signal transmission-reception simulation package, and/or a combination of software and hardware used to operate, or simulate the operation of various potential embodiments.

It should also be understood that the apparatus and systems of various embodiments can be used in applications other than dispensing flux onto substrates, and thus, various embodiments are not to be so limited. The illustrations of apparatus 100 and systems 110 are intended to provide a general understanding of the structure of various embodiments, and they are not intended to serve as a complete description of all the elements and features of apparatus and systems that might make use of the structures described herein. Such apparatus and systems may further be included as sub-components within a variety of electronic systems and processes, such as circuit packaging machines, circuit assembly machines, circuit assembly stations, and circuit assembly lines, among others.

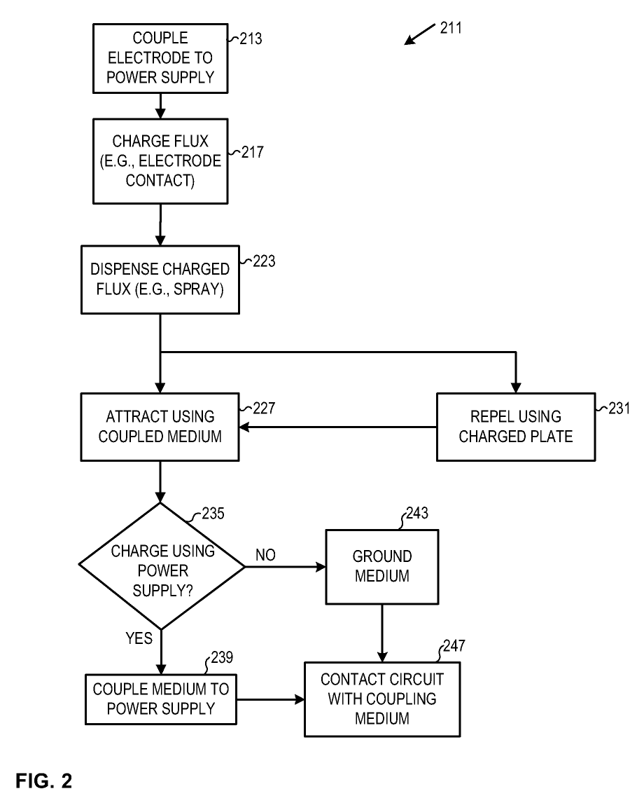

Some embodiments may include a number of methods. For example, FIG. 2 is a flow diagram illustrating several methods 211 according to various embodiments of the invention. A flux dispensing method 211 may (optionally) begin with coupling a charging electrode (perhaps disposed within a quantity of flux) to a charging power supply at block 213. The method 211 may continue at block 217 with charging the quantity of flux using a first charge to provide a charged flux portion, and then dispensing the charged flux portion toward a circuit at block 223.

In some embodiments, the method 211 may include directing distribution of the charged flux portion using a second charge to attract (at block 227) or repel (at block 231) the charged flux portion. For example, directing distribution within the method 211 may include attracting the charged flux portion at block 227 by coupling the circuit to the second charge, wherein the second charge is different from the first charge. Directing distribution within the method 211 may include, as an alternative, or in addition, repelling the charged flux portion at block 231 by locating a plate charged with a second charge proximate to the charged flux portion, wherein the second charge is the same as the first charge. Locating the plate at block 231 may include moving the plate and a dispensing nozzle attached to the plate as an integral assembly.

If distribution of the flux is directed using attraction at block 227, and a conductive medium is to be coupled to the circuit to induce attraction of the charged flux, then the method 211 may include charging the conductive medium using a power supply. If this is the case, as determined at block 235, then the method 211 may include coupling the conductive medium to a charging power supply at block 239, and then contacting at least a portion of the circuit with a conductive medium at block 247. If the conductive medium is not to be charged by coupling to a power supply, as determined at block 235, then the method 211 may include grounding the conductive medium at block 243, and then contacting at least a portion of the circuit with a conductive medium at block 247.

Many variations in the method 211 may be realized. For example, the method 211 may include, at block 223, spraying the charged flux portion through a dispensing nozzle after contacting at least some part of a quantity of flux with a charging electrode at block 217. In some embodiments, the method 211 may include contacting selected portions of the circuit with a conductive medium at block 247, wherein the conductive medium is coupled to a second charge different from the first charge (associated with the charged flux).

It should be noted that the methods described herein do not have to be executed in the order described, or in any particular order. Moreover, various activities described with respect to the methods identified herein can be executed in repetitive, simultaneous, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment, including hypertext markup language (HTML) and extensible markup language (XML).

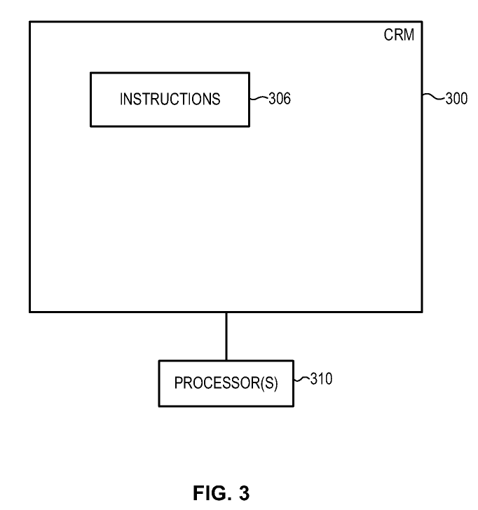

Thus, other embodiments may be realized. For example, FIG. 3 is a block diagram of a computer-readable medium (CRM) 300 according to various embodiments of the invention. Examples of such embodiments may comprise a memory system, a magnetic or optical disk, or some other storage device. The CRM 300 may contain instructions 306 which, when accessed, result in one or more processors 310 performing any of the activities previously described, including those discussed with respect to the methods 211 noted above. For example, the CRM 300 may comprise firmware used to simulate the operations described above, or to direct the execution of such operations in association with a machine in a manufacturing and/or assembly environment.

Thus, in some embodiments, a CRM 300 may have instructions 306 stored thereon which, when executed by a computer (e.g., processors(s) 310), cause the computer to perform a method comprising charging a quantity of flux using a first charge to provide a charged flux portion, dispensing the charged flux portion toward a circuit, and directing distribution of the charged flux portion using a second charge to attract or repel the charged flux portion.

The instructions 306, when executed by the computer, may also cause the computer to perform a method comprising spraying the charged flux portion through a dispensing nozzle after contacting at least a part of the quantity of flux with a charging electrode, as well as contacting selected portions of the circuit with a conductive medium coupled to the second charge different from the first charge. Other acts may also be performed, as described above.

Implementing the apparatus, systems, and methods disclosed herein may provide a more precise mechanism to control flux overspray. In some cases, the need for defluxing to remove flux residue on a substrate may be substantially reduced, or even eliminated. Underfill voiding due to the application of excessive flux may also be reduced, as well as the need to use no-clean flux formulations.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

As used herein, terminology such as “vertical,” “horizontal,” “top,” “bottom,” “front,” and “back” are referenced according to the views presented. It should be understood, however, that these terms are used only for purposes of description, and are not intended to be used as limitations, unless specifically recited in the claims.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, comprising:
a flux reservoir;
a dispensing nozzle capable of being in fluid communication with the flux reservoir; and
a charging electrode proximate to the dispensing nozzle or the flux reservoir.

2. The apparatus of claim 1, comprising:
a charging power supply to be electrically coupled to the charging electrode.

3. The apparatus of claim 2, wherein the charging power supply is capable of supplying a charging voltage of approximately IkV to 150 kV.

4. The apparatus of claim 1, wherein the charging electrode is disposed within a chamber of the dispensing nozzle, the chamber being partially bounded by an outlet of the dispensing nozzle.

5. The apparatus of claim 1, wherein the charging electrode is disposed within the flux reservoir or within a conduit coupling the flux reservoir to the dispensing nozzle.

6. The apparatus of claim 1, comprising:
at least one chargeable plate coupled to a charging power supply and moveable to direct charged flux exiting the dispensing nozzle away from the at least one chargeable plate.

7. The apparatus of claim 6, wherein the at least one chargeable plate comprises two substantially opposable plates.

8. The apparatus of claim 6, wherein the at least one chargeable plate comprises two pairs of substantially opposable plates.

9. The apparatus of claim 6, comprising:
a flux seal to be located proximate to the at least one chargeable plate.

10. The apparatus of claim 9, wherein the flux seal comprises one of polytetrafluoroethylene, a silicone-based rubber, urethane, or a thermoplastic elastomer.

11. The apparatus of claim 1, comprising:
a valve to control the fluid communication between the flux reservoir and the dispensing nozzle.

12. The apparatus of claim 1, wherein the dispensing nozzle forms a portion of the flux reservoir.

13. A system, comprising:
a flux reservoir;
a dispensing nozzle capable of being in fluid communication with the flux reservoir;
a charging electrode proximate to the dispensing nozzle or the flux reservoir; and
a conductive medium to electrically couple to a circuit having conductors to attract charged flux exiting the dispensing nozzle.

14. The system of claim 13, wherein the conductive medium comprises a substantially compliant conductive medium.

15. The system of claim 13, wherein the substantially compliant conductive medium comprises one of a conductive polymer, a conductive rubber, a conductive mesh, or a compliant solder.

16. The system of claim 13, comprising:
a substrate attached to the conductors, wherein the conductors include at least one of solder bumps or solder pads.

17. The system of claim 13, comprising:
a power supply coupled to the charging electrode.

18. The system of claim 13, comprising:
at least one chargeable plate coupled to a charging power supply and moveable to direct charged flux exiting the dispensing nozzle away from the at least one chargeable plate.

19. The system of claim 13, comprising:
at least one non-charged plate to shield a portion of a substrate attached to the conductors from charged flux exiting the dispensing nozzle.

20. A method, comprising:
charging a quantity of flux using a first charge to provide a charged flux portion;
dispensing the charged flux portion toward a circuit; and
directing distribution of the charged flux portion using a second charge to attract or repel the charged flux portion.

21. The method of claim 20, wherein the charging comprises:
coupling a charging electrode disposed within the quantity of flux to a charging power supply.

22. The method of claim 20, wherein the directing comprises:
repelling the charged flux portion by locating a plate charged with the second charge proximate to the charged flux portion, wherein the second charge is the same as the first charge.

23. The method of claim 22, wherein the locating comprises:
moving the plate and a dispensing nozzle attached to the plate as an integral assembly.

24. The method of claim 20, wherein the directing comprises:
attracting the charged flux portion by coupling the circuit to the second charge, wherein the second charge is different from the first charge.

25. The method of claim 24, wherein the coupling comprises:
contacting at least a portion of the circuit with a conductive medium.

26. The method of claim 25, comprising:
grounding the conductive medium.

27. The method of claim 25, comprising:
coupling the conductive medium to a charging power supply.

28. A computer-readable medium having instructions stored thereon which, when executed by a computer, cause the computer to perform a method comprising:
charging a quantity of flux using a first charge to provide a charged flux portion;
dispensing the charged flux portion toward a circuit; and
directing distribution of the charged flux portion using a second charge to attract or repel the charged flux portion.

29. The computer-readable medium of claim 28, wherein the instructions, when executed by the computer, cause the computer to perform a method comprising:
spraying the charged flux portion through a dispensing nozzle after contacting at least a part of the quantity of flux with a charging electrode.

30. The computer-readable medium of claim 28, wherein the instructions, when executed by the computer, cause the computer to perform a method comprising:
contacting selected portions of the circuit with a conductive medium coupled to the second charge different from the first charge.
